(19) United States
(12) Patent Application Publication
(10) Pub. No.: US 2016/0371216 A1
(43) Pub. Date: Dec. 22, 2016

(54) CAPACITOR INTERCONNECTIONS AND VOLUME RE-CAPTURE FOR VOLTAGE NOISE REDUCTION

(71) Applicant: Intel Corporation, Santa Clara, CA (US)

(72) Inventors: Sameer Shekhar, Portland, OR (US); Amit K. Jain, Portland, OR (US)

(73) Assignee: Intel Corporation, Santa Clara, CA (US)

(21) Appl. No.: 14/742,695

(22) Filed: Jun. 17, 2015

(51) Int. Cl. G06F 13/40; G06F 1/26

(52) U.S. Cl. CPC G06F 13/4068; G06F 1/26

(57) ABSTRACT

Methods and apparatus relating to capacitor interconnections and/or volume re-capture for voltage noise reduction are described. In an embodiment, an interconnection capacitor is coupled to voltage regulator logic. The interconnection capacitor provides substrate decoupling for a plurality of loads. Other embodiments are also disclosed and claimed.

### FIELD

The present disclosure generally relates to the field of electronics. More particularly, some embodiments relate to capacitor interconnections and/or volume re-capture for voltage noise reduction.

### BACKGROUND

Generally, power delivery noise suppression relies on substrate decoupling in the form of discrete capacitors. The capacitor choice can be made through independent analyses for each load. However, the total capacitance is limited by available space which shrinks with semiconductor process.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 8-10 illustrate block diagrams of embodiments of computing systems, which may be utilized to implement various embodiments discussed herein.

FIGS. 2A-2B illustrate circuit diagrams, according to some embodiments.

FIGS. 3A, 3B, and 3C illustrate capacitance structures, according to some embodiments.

FIGS. 4 and 5D illustrate sample graphs according to some embodiments.

FIGS. 5A-5C illustrate various semiconductor footprints, according to some embodiments.

FIGS. 6 and 7 illustrates different capacitor configurations, topologies, and shapes, according to some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

As mentioned above, Power Delivery Network (PDN) noise suppression generally requires substrate decoupling in form of discrete capacitors. For example, these can be placed in an array of two or more capacitors (e.g., a rectangular array), catering to multiple loads with different nominal DC (Direct Current) voltage. The capacitor choice can be made through independent analyses for each load. Such approaches, however, fail to exploit knowledge of correlation between different loads. Also, the total capacitance is limited by available space which shrinks with semiconductor process.

To this end, some embodiments provide capacitor interconnections (or capacitor structure(s)) and/or volume re-capture for voltage noise reduction. An embodiment exploits load correlation and/or realizes multiple decoupling capacitors in a (e.g., single) structure that can recapture unused volume. Hence, a similar level of noise mitigation can be provided utilizing a similar decoupling area; alternatively or in addition, providing similar performance (or capacitance value) with less area utilization in accordance with some embodiments.

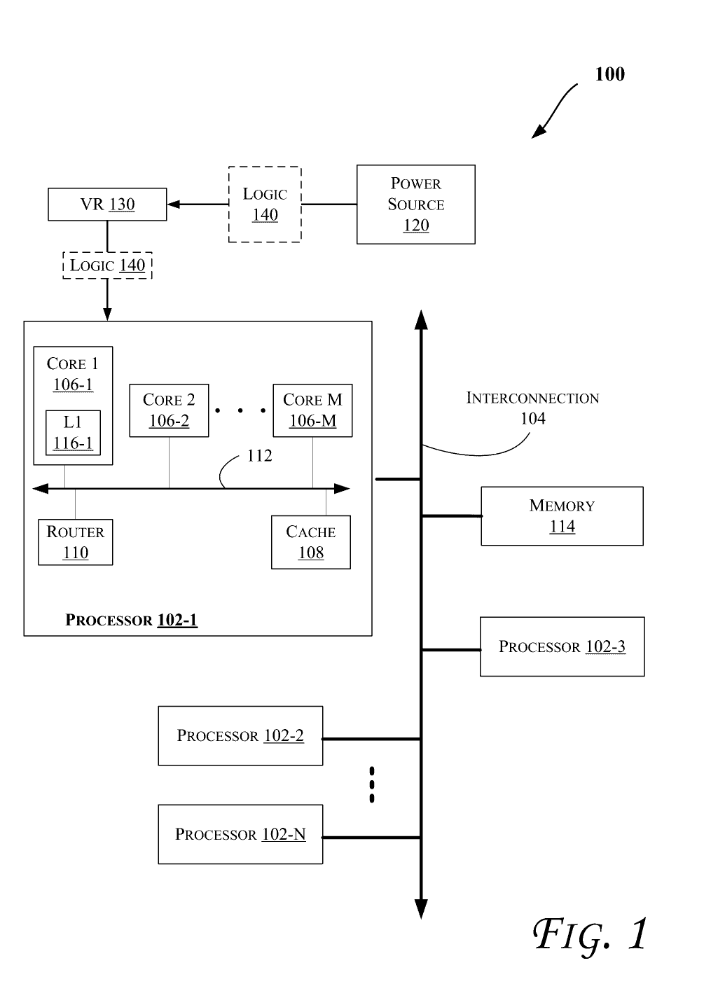

Furthermore, some embodiments may be applied in computing systems that include one or more processors (e.g., with one or more processor cores), such as those discussed with reference to FIGS. 1-10, including for example mobile computing devices (and/or platforms) such as a smartphone, tablet, UMPC (Ultra-Mobile Personal Computer), laptop computer, Ultrabook™ computing device, smart watch, smart glasses, wearable devices, etc., and/or larger systems such as computer servers with many cores, etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

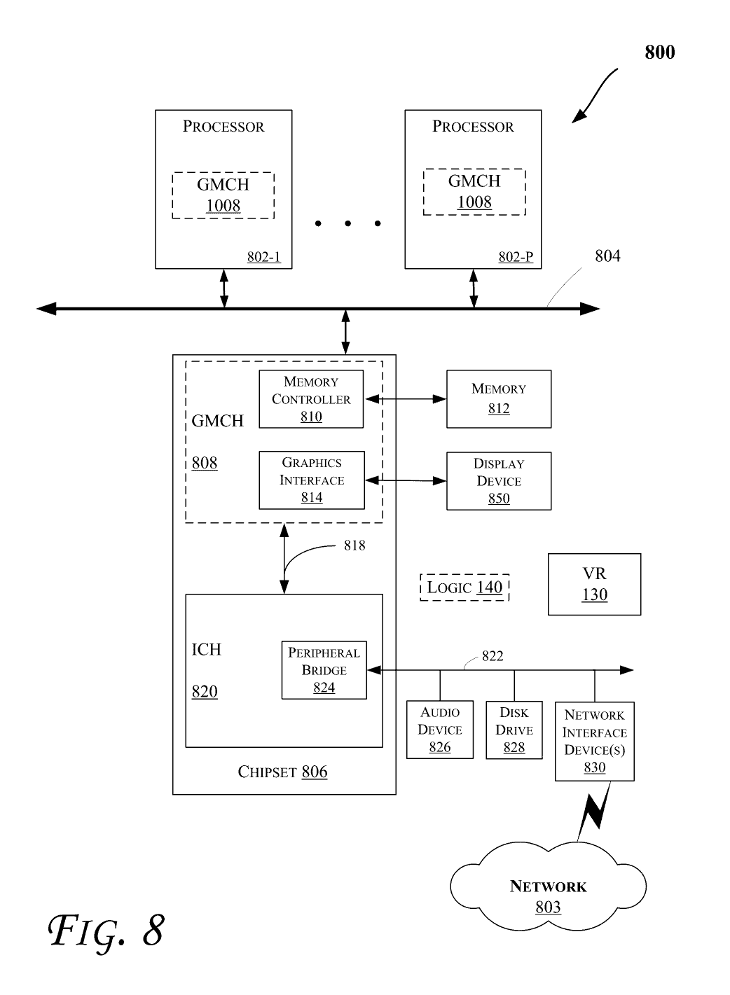

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 8-10), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a platform power source 120 (e.g., a Direct Current (DC) power source or an Alternating Current (AC) power source) to provide power to one or more components of the system 100. The power source 120 could include a PV (Photo Voltaic) panel, wind generator, thermal generator water/hydro turbine, etc. In some embodiments, the power source 120 may include one or more battery packs (e.g., charged by one or more of a PV panel, wind generator, thermal generator water/hydro turbine, plug-in power supply (for example, coupled to an AC power grid), etc.) and/or plug-in power supplies. The power source 120 may be coupled to components of system 100 through a Voltage Regulator (VR) 130. Moreover, even though FIG. 1 illustrates one power source 120 and a single voltage regulator 130, additional power sources and/or voltage regulators may be utilized. For example, one or more of the processors 102 may have corresponding voltage regulator(s) and/or power source(s). Also, the voltage regulator(s) 130 may be coupled to the processor 102 (and/or cores 106) via a single power plane (e.g., supplying power to all the cores 106) or multiple power planes (e.g., where each power plane may supply power to a different core or group of cores).

As discussed herein, various type of voltage regulators may be utilized for the VR 130. For example, VR 130 may include a “buck” VR (which is generally used in power delivery applications in which an input voltage needs to be transformed to an output voltage in a ratio that is smaller than unity) or a “boost” VR (which is generally used in power delivery applications in which an input voltage needs to be transformed to an output voltage in a ratio that is larger than unity), combinations thereof such as a buck-boost VR, etc. Furthermore, in an embodiment, a dual phase, e.g., that may be extendable to multi-phase three-Level buck VR topology.

Additionally, while FIG. 1 illustrates the power source 120 and the voltage regulator 130 as separate components, the power source 120 and the voltage regulator 130 may be incorporated into other components of system 100. For example, all or portions of the VR 130 may be incorporated into the power source 120 and/or processor 102.

As shown in FIG. 1, system 100 may further include logic 140 to provide capacitor interconnections and/or volume re-capture for voltage noise reduction, e.g., as discussed herein with reference to some embodiments. In an embodiment, logic 140 is provided on a reconfigurable power management ICs (RPMICs), such as a PMIC (Power Management IC) and/or an IMVP (Intel® Mobile Voltage Positioning). Such RPMIC implementation(s) may be used in low power devices (such as portable devices discussed herein) through large computer servers such as discussed herein with reference to FIG. 1 or 8-10.

As shown, the logic 140 may be coupled to the VR 130 and/or other components of system 100 such as the processor 102 (and/or cores 106) and/or the power source 120. Also, logic 140 may be provide elsewhere in system 100, such as inside the VR 130, inside the processor 102, inside the power source 120, etc.

As discussed herein, an embodiment uses decoupling available in different domains by introducing interconnection capacitor(s) between loads along with realization of the decoupling and interconnection capacitors in a new structure that results in a lower noise per unit decoupling volume for any load combination.

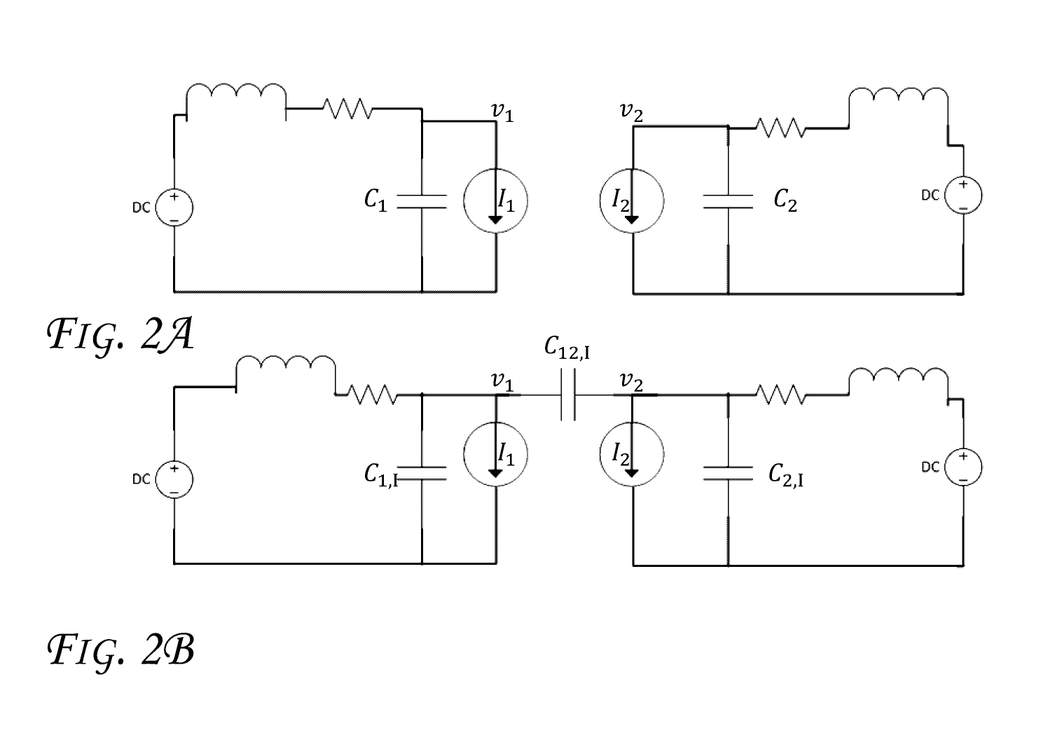

FIG. 2A illustrates two independent loads connected to a VR (Voltage Regulator) through package parasitics. FIG. 2B illustrates an interconnection capacitor provided between loads. While two loads are discussed herein with reference to some implementations, embodiments may be applied to more than two loads.

More particularly, FIG. 2A shows a representation of two adjacent loads with independent decoupling capacitors (C₁ and C₂). Referring to FIG. 2B, an embodiment uses an interconnection capacitor (C_{12,I}) connected between two different domains (e.g., having independent voltage for two separate voltage domains) or loads. This allows Load1 (I₁) to leverage the decoupling solution of Load2 (I₂) resulting in relatively superior noise reduction. The interconnection capacitor may be provided as a capacitor on a semiconductor package or a motherboard, on die or as a separate standalone component (on an integrated circuit die side or on the load side).

For illustration purposes, we consider the case where Load1 and Load2 are inversely correlated, i.e., when I₁ increases, I₂ decreases. We also consider a fixed total amount of capacitance (or volume) to show the benefit. Without the interconnection, we have C₁=C₂=3C with a total capacitance of 6C. With an interconnection according to an embodiment, we redistribute as: C_{1,I}=C_{2,I}=C_{12,I}=2C, with the same total capacitance of 6C. Assuming all the initial load current is supplied by the capacitances, the voltage noise resulting without interconnection is:

$${v}_{1} = \frac{{I}_{1}}{jω {C}_{1}} ;$$

$${v}_{2} = \frac{{I}_{2}}{jω {C}_{2}} ;$$

$$with$$

$${I}_{1} = - {I}_{2} = I , \\ {v}_{1} = - {v}_{2} = \frac{I}{3 jω C}$$

With an interconnection (according to an embodiment), the noise is:

$${v}_{1 , I} = {z}_{11} {I}_{1} + {z}_{12} {I}_{2} ;$$

$$where , {z}_{11} = {\{ jω [ {C}_{1 , I} + \frac{{C}_{12 , I} {C}_{2 , I}}{{C}_{12 , I} + {C}_{2 , I}} ] \}}^{- 1} = \frac{1}{3 jω C} ;$$

$${z}_{12} = \frac{{C}_{2}}{{C}_{1} + {C}_{2}} {\{ jω [ {C}_{2 , I} + \frac{{C}_{12 , I} {C}_{1 , I}}{{C}_{12 , I} + {C}_{1 , I}} ] \}}^{- 1} = \frac{1}{6 jω C}$$

$$with$$

$${I}_{1} = - {I}_{2} = 1 , \\ {v}_{1 , I} = \frac{I}{6 jω C} = - {v}_{2 , I}$$

Hence, for this example, by repartitioning/restructuring the capacitance, the noise at each load is reduced by a factor of two.

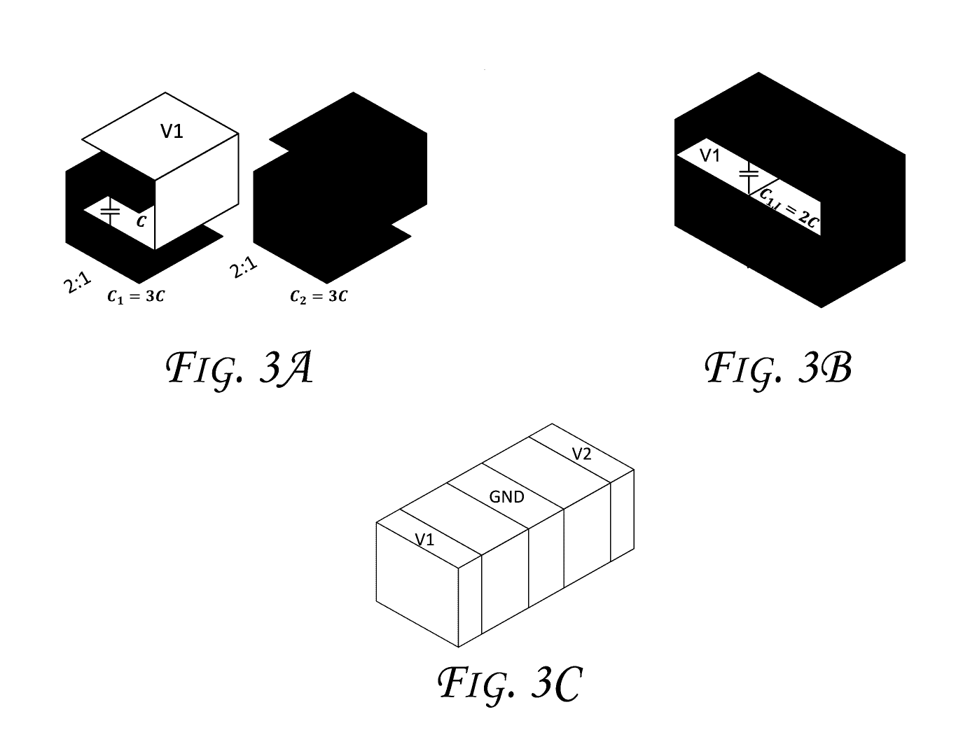

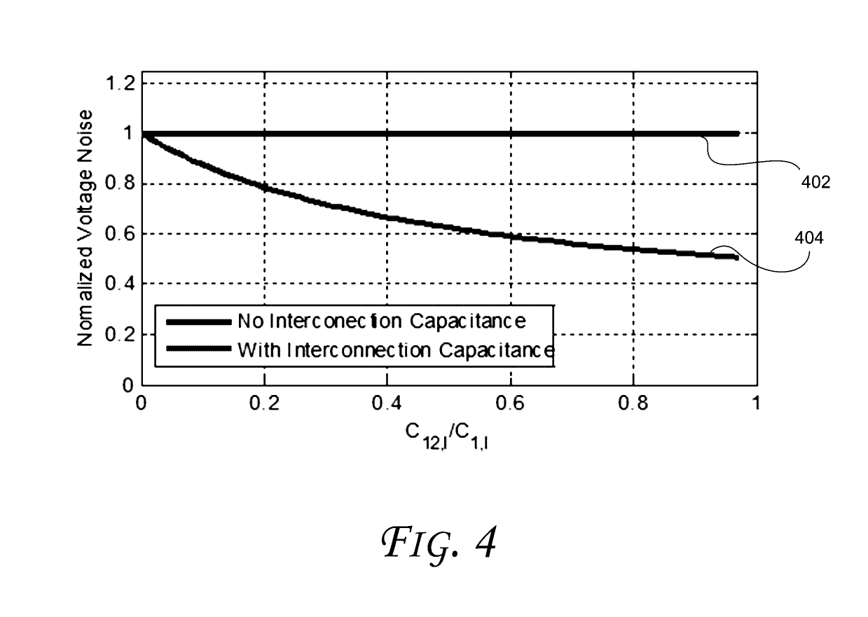

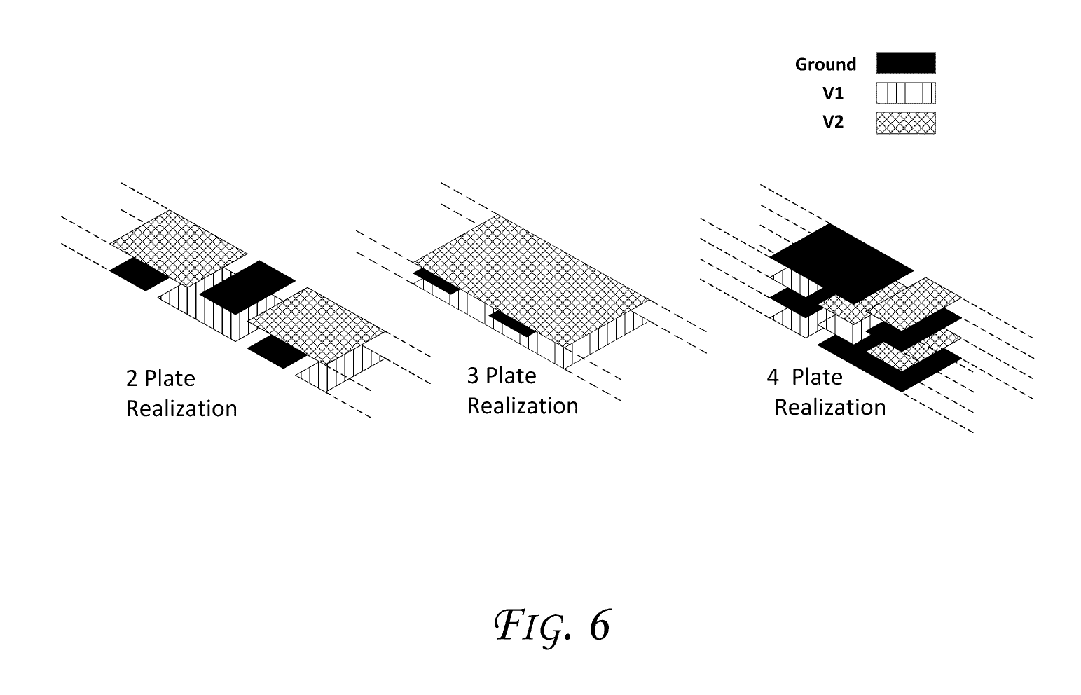

FIGS. 3A, 3B, and 3C illustrate various capacitance structures, according to some embodiments. FIG. 3A shows an independent capacitor plate arrangement. FIG. 3B illustrates interconnected capacitors. FIG. 3C shows a packaged three terminal capacitor. Moreover, FIG. 3A shows use of four-plates for implementing two individual capacitors C₁ and C₂. It is assumed that the separation between plates at minimum spacing, e.g., set by manufacturing and electrical breakdown targets. The structure for an embodiment is shown in FIG. 3B depicting one optimal use of plate arrangement for servicing the inversely correlated loads. This forms the capacitances, C_{1,I}, C_{2,I} & C_{12,I} shown in the schematic of FIG. 2B. The entire parallel plate capacitor can then be packaged to form a three terminal final assembly shown in FIG. 3C. An asymmetric interconnection capacitor can also be constructed by varying the planar area of plates, for example, combining FIG. 3B and 4-plate realization in FIG. 6.

FIG. 4. illustrates sample graphs showing voltage noise advantage of interconnected capacitors, according to an embodiment. Graph 402 corresponds to sample values for no interconnection capacitance, while graph 404 shows sample values with interconnection capacitance. Moreover, the noise impact of varying the interconnection capacitor while keeping the volume constant is shown in FIG. 4. As illustrated, noise reduces as the interconnection capacitance increases.

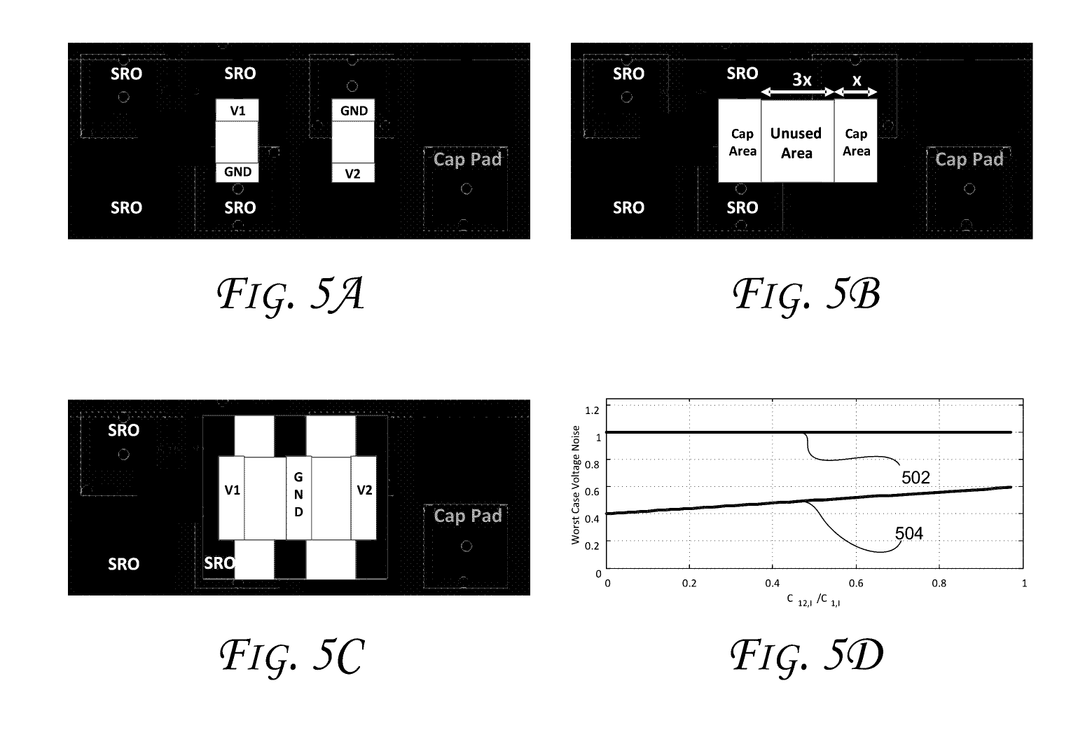

FIGS. 5A-5C illustrate various semiconductor packaging footprints, according to some embodiments. FIG. 5D illustrates a sample graph of noise improvement embodiments versus an existing solution. More particularly, FIG. 5A shows a substrate footprint for two capacitors decoupling two different loads (e.g., in accordance with 0402 form factor); FIG. 5B illustrates unused volume utilization opportunity. FIG. 5C shows three terminal capacitor in the same substrate footprint and FIG. 5D illustrates SRO (Solder Resist Opening) recapture outperforms existing solution for all load scenarios, including positively/inversely co-related (by any amount), and/or independent loads.

Moreover, FIG. 5A shows a substrate view of adjacent capacitors. Substrate technology uses SRO-to-SRO spacing as a design rule for placement. Actual capacitor area is a small percentage of total capacitor footprint area as shown in FIG. 5B. Instead of using two capacitors for decoupling two different loads, an embodiment replaces two capacitors by one three terminal capacitor with the structure of FIG. 3B. The new capacitor includes the interconnection capacitor and has increased form factor as shown in FIG. 5C. The structure in 5C provides two and a half times increase in dielectric area and therefore two and a half times increase in capacitance in the same area as the two capacitors of FIG. 5A. The volume recaptured in the new capacitor increases the capacitance/volume and benefits various (e.g., all possible) load combinations, including positively/inversely co-related (by any amount), and/or independent loads (i.e., loads that are not co-related).

FIG. 5D shows this advantage across various loads covering positively or inversely correlated and independent loads. Graph 502 corresponds to sample values for no interconnection capacitance, while graph 504 shows sample values with interconnection capacitance. Only the worst case noise is plotted for clarity. The increase in capacitance per unit substrate area helps shrink decoupling area along with process shrink without performance degradation. For example, voltage rails that rely on adjacent placement of decoupling capacitors will benefit immensely from such an embodiment, but the benefit applies to all used solutions.

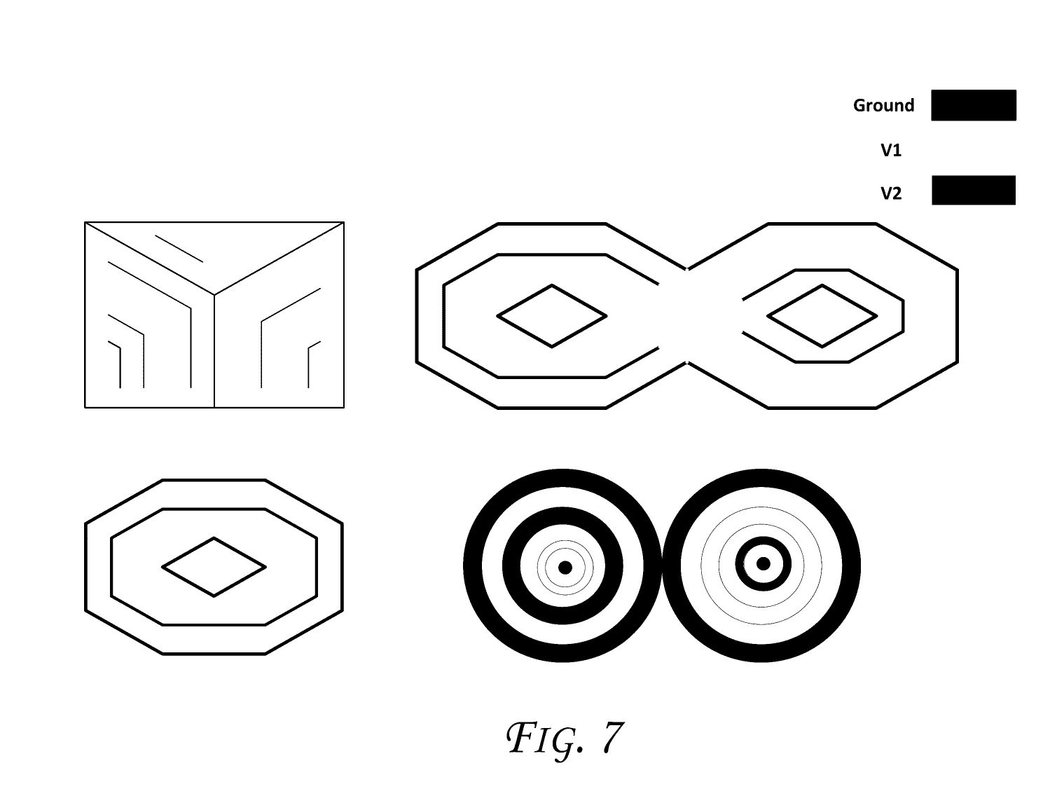

While some implementations are discussed herein with respect to a sample number of plates, other number of plates or plate configurations may be used in various embodiments such as discussed with reference to FIGS. 6 and/or 7. For example, one embodiment can be realized with different number of plates, and multiple stacking of the unit capacitor cell. FIG. 6 shows realization of the capacitor unit for two, three, and four plates examples. Opportunities exist to realize an embodiment as non-planar topologies such as shown in FIG. 7 as well. Hence, various types of geometric shapes may be used to provide the interconnection capacitor, such as circular and non-circular shapes.

Accordingly, some embodiments utilize a combination of circuitry, load knowledge, capacitor structure, and/or area utilization. Various embodiments provide one or more of: (a) help product performance by countering the impact of decoupling area reduction due to process shrink; (b) enable package substrate size reduction via better utilization of decoupling area; (c) due to increased effectiveness of capacitor, it will be possible to obtain the same or similar noise performance with lower profile capacitors, e.g., ultra-low profile capacitors (˜150 um) could deliver the same or similar performance as extra low profile capacitors (˜220 um); (d) lower power delivery components on the motherboard reducing form factor for compelling end product; (e) design flexibility of being able to trade performance vs. cost among different product lines; (f) advantage through form factor reduction; and/or EMI (Electro-Magnetic Interference) filter applications with platform benefits.

Hence, some voltage noise mitigation is provided through novel capacitance structures, e.g., by provision of: (a) capacitor interconnection between loads; and/or (b) utilization of unused area or volume. Moreover, one embodiment proposes a new circuit and structure to enhance decoupling solutions by greater than 40% in the same area. This is critical to address process shrink without performance degradation.

FIG. 8 illustrates a block diagram of a computing system 800 in accordance with an embodiment. The computing system 800 may include one or more central processing unit(s) (CPUs) or processors 802-1 through 802-P (which may be referred to herein as “processors 802” or “processor 802”). The processors 802 may communicate via an interconnection network (or bus) 804. The processors 802 may include a general purpose processor, a network processor (that processes data communicated over a computer network 803), or other types of a processor (including a reduced instruction set computer (RISC) processor or a complex instruction set computer (CISC)). Moreover, the processors 802 may have a single or multiple core design. The processors 802 with a multiple core design may integrate different types of processor cores on the same integrated circuit (IC) die. Also, the processors 802 with a multiple core design may be implemented as symmetrical or asymmetrical multiprocessors. In an embodiment, one or more of the processors 802 may be the same or similar to the processors 102 of FIG. 1. In some embodiments, one or more of the processors 802 may include one or more of the cores 106, VR 130, and/or logic 140 of FIG. 1. Also, the operations discussed with reference to FIGS. 1-7 may be performed by one or more components of the system 800. For example, a voltage regulator (such as VR 130 of FIG. 1) may regulate voltage supplied to one or more components of FIG. 8 in conjunction with logic 140.

A chipset 806 may also communicate with the interconnection network 804. The chipset 806 may include a graphics and memory control hub (GMCH) 808. The GMCH 808 may include a memory controller 810 that communicates with a memory 812. The memory 812 may store data, including sequences of instructions that are executed by the processor 802, or any other device included in the computing system 800. In one embodiment, the memory 812 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 804, such as multiple CPUs and/or multiple system memories.

The GMCH 808 may also include a graphics interface 814 that communicates with a display device 850, e.g., a graphics accelerator. In one embodiment, the graphics interface 814 may communicate with the display device 850 via an accelerated graphics port (AGP) or Peripheral Component Interconnect (PCI) (or PCI express (PCIe) interface). In an embodiment, the display device 850 (such as a flat panel display (such as an LCD (Liquid Crystal Display), a cathode ray tube (CRT), a projection screen, etc.) may communicate with the graphics interface 814 through, for example, a signal converter that translates a digital representation of an image stored in a storage device such as video memory or system memory into display signals that are interpreted and displayed by the display. The display signals produced may pass through various control devices before being interpreted by and subsequently displayed on the display device 850.

A hub interface 818 may allow the GMCH 808 and an input/output control hub (ICH) 820 to communicate. The ICH 820 may provide an interface to I/O devices that communicate with the computing system 800. The ICH 820 may communicate with a bus 822 through a peripheral bridge (or controller) 824, such as a peripheral component interconnect (PCI) bridge, a universal serial bus (USB) controller, or other types of peripheral bridges or controllers. The bridge 824 may provide a data path between the processor 802 and peripheral devices. Other types of topologies may be utilized. Also, multiple buses may communicate with the ICH 820, e.g., through multiple bridges or controllers. Moreover, other peripherals in communication with the ICH 820 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 822 may communicate with an audio device 826, one or more disk drive(s) 828, and one or more network interface device(s) 830 (which is in communication with the computer network 803). Other devices may communicate via the bus 822. Also, various components (such as the network interface device 830) may communicate with the GMCH 808 in some embodiments. In addition, the processor 802 and the GMCH 808 may be combined to form a single chip. Furthermore, the graphics accelerator may be included within the GMCH 808 in other embodiments.

Furthermore, the computing system 800 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 828), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 800 may be arranged in a point-to-point (PtP) configuration. For example, processors, memory, and/or input/output devices may be interconnected by a number of point-to-point interfaces.

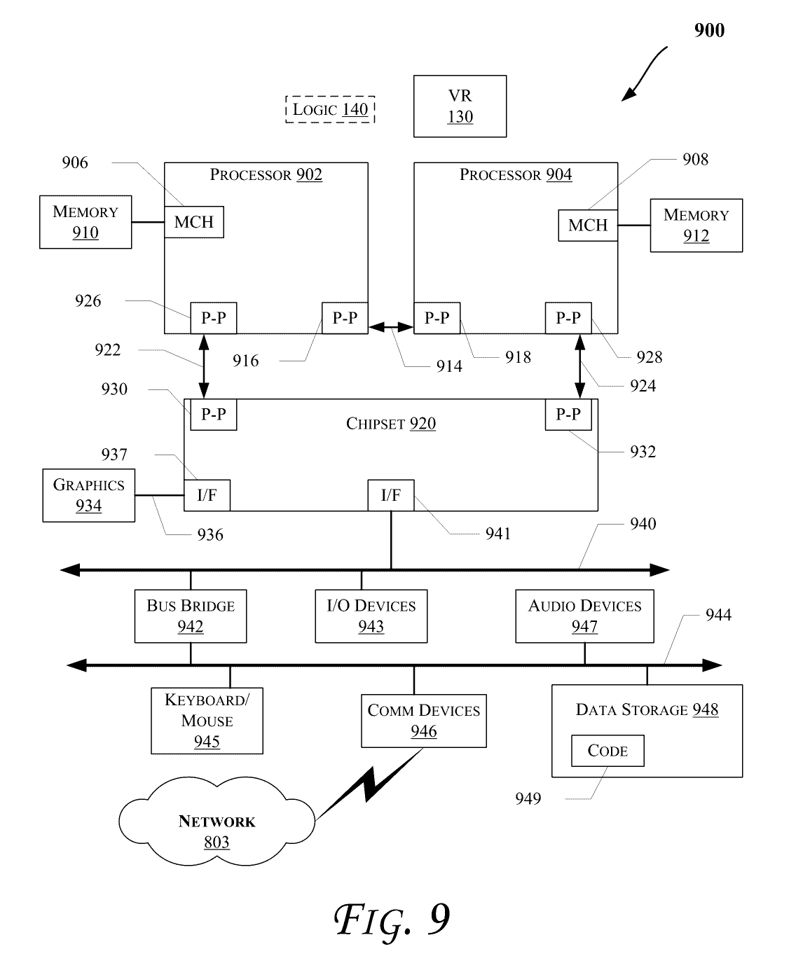

FIG. 9 illustrates a computing system 900 that is arranged in a point-to-point (PtP) configuration, according to an embodiment. In particular, FIG. 9 shows a system where processors, memory, and input/output devices are interconnected by a number of point-to-point interfaces. The operations discussed with reference to FIGS. 1-8 may be performed by one or more components of the system 900. For example, a voltage regulator (such as VR 130 of FIG. 1) may regulate voltage supplied to one or more components of FIG. 9 in conjunction with logic 140.

As illustrated in FIG. 9, the system 900 may include several processors, of which only two, processors 902 and 904 are shown for clarity. The processors 902 and 904 may each include a local memory controller hub (MCH) 906 and 908 to enable communication with memories 910 and 912. The memories 910 and/or 912 may store various data such as those discussed with reference to the memory 812 of FIG. 8. Also, the processors 902 and 904 may include one or more of the cores 106, logic 140, and/or VR 130 of FIG. 1.

In an embodiment, the processors 902 and 904 may be one of the processors 802 discussed with reference to FIG. 8. The processors 902 and 904 may exchange data via a point-to-point (PtP) interface 914 using PtP interface circuits 916 and 918, respectively. Also, the processors 902 and 904 may each exchange data with a chipset 920 via individual PtP interfaces 922 and 924 using point-to-point interface circuits 926, 928, 930, and 932. The chipset 920 may further exchange data with a high-performance graphics circuit 934 via a high-performance graphics interface 936, e.g., using a PtP interface circuit 937.

In at least one embodiment, one or more operations discussed with reference to FIGS. 1-9 may be performed by the processors 902 or 904 and/or other components of the system 900 such as those communicating via a bus 940. Other embodiments, however, may exist in other circuits, logic units, or devices within the system 900 of FIG. 9. Furthermore, some embodiments may be distributed throughout several circuits, logic units, or devices illustrated in FIG. 9.

Chipset 920 may communicate with the bus 940 using a PtP interface circuit 941. The bus 940 may have one or more devices that communicate with it, such as a bus bridge 942 and I/O devices 943. Via a bus 944, the bus bridge 942 may communicate with other devices such as a keyboard/mouse 945, communication devices 946 (such as modems, network interface devices, or other communication devices that may communicate with the computer network 803), audio I/O device, and/or a data storage device 948. The data storage device 948 may store code 949 that may be executed by the processors 902 and/or 904.

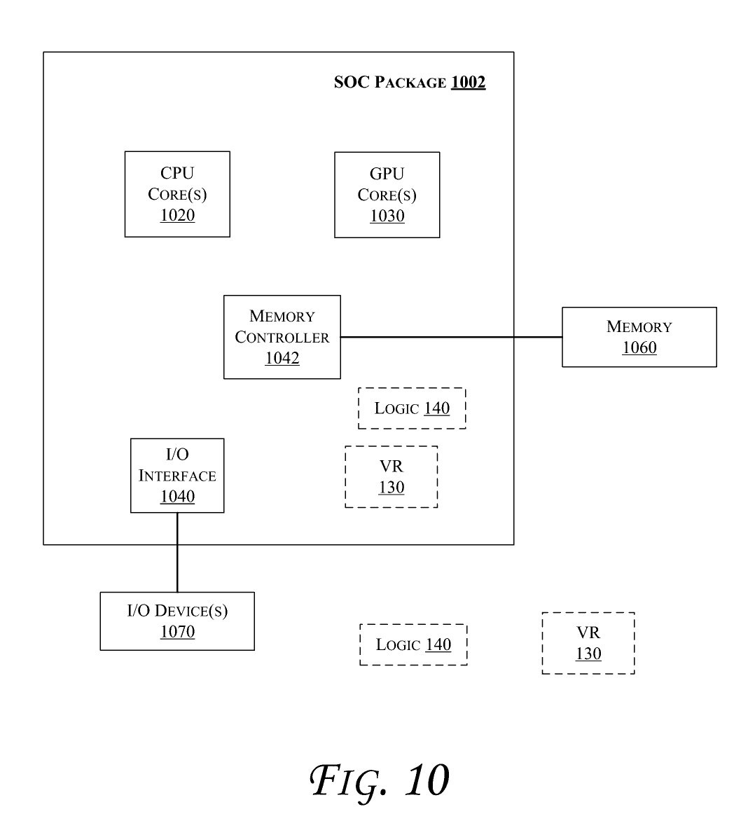

In some embodiments, one or more of the components discussed herein can be embodied as a System On Chip (SOC) device. FIG. 10 illustrates a block diagram of an SOC package in accordance with an embodiment. As illustrated in FIG. 10, SOC 1002 includes one or more Central Processing Unit (CPU) cores 1020, one or more Graphics Processor Unit (GPU) cores 1030, an Input/Output (I/O) interface 1040, and a memory controller 1042. Various components of the SOC package 1002 may be coupled to an interconnect or bus such as discussed herein with reference to the other figures. Also, the SOC package 1002 may include more or less components, such as those discussed herein with reference to the other figures. Further, each component of the SOC package 1020 may include one or more other components, e.g., as discussed with reference to the other figures herein. In one embodiment, SOC package 1002 (and its components) is provided on one or more Integrated Circuit (IC) die, e.g., which are packaged into a single semiconductor device.

As illustrated in FIG. 10, SOC package 1002 is coupled to a memory 1060 (which may be similar to or the same as memory discussed herein with reference to the other figures) via the memory controller 1042. In an embodiment, the memory 1060 (or a portion of it) can be integrated on the SOC package 1002.

The I/O interface 1040 may be coupled to one or more I/O devices 1070, e.g., via an interconnect and/or bus such as discussed herein with reference to other figures. I/O device(s) 1070 may include one or more of a keyboard, a mouse, a touchpad, a display, an image/video capture device (such as a camera or camcorder/video recorder), a touch screen, a speaker, or the like. Furthermore, SOC package 1002 may include/integrate the logic 140 and/or VR 130 in an embodiment. Alternatively, the logic 140 and/or VR 130 may be provided outside of the SOC package 1002 (i.e., as a discrete logic).

The following examples pertain to further embodiments. Example 1 includes an apparatus comprising: an interconnection capacitor coupled to voltage regulator logic, wherein the interconnection capacitor is to provide substrate decoupling for a plurality of loads. Example 2 includes the apparatus of example 1, wherein a first node of the interconnection capacitor is to be coupled to a first node of a first load of the plurality of loads and a second node of the interconnection capacitor is to be coupled to a first node of a second node of the plurality of loads. Example 3 includes the apparatus of example 2, wherein a second node of the first load is to be coupled to the first node of the interconnection capacitor via a first voltage source and a second node of the second load is to be coupled to the second node of the interconnection capacitor via a second voltage source. Example 4 includes the apparatus of example 3, wherein the first voltage source and the second voltage source are to be coupled to the voltage regulator logic. Example 5 includes the apparatus of example 1, wherein the interconnection capacitor is to comprise a capacitor on a semiconductor package or on a motherboard. Example 6 includes the apparatus of example 1, wherein the interconnection capacitor is a separate component on an integrated circuit die or on a load side. Example 7 includes the apparatus of example 1, wherein the interconnection capacitor is to be coupled between the voltage regulator logic and a power source. Example 8 includes the apparatus of example 1, wherein the interconnection capacitor is to be coupled between the voltage regulator logic and a processor having one or more processor cores. Example 9 includes the apparatus of example 1, wherein the voltage regulator logic is to comprise one or more of: a buck voltage regulator logic, a boost voltage regulator logic, or combinations thereof. Example 10 includes the apparatus of example 1, wherein the voltage regulator logic is to comprise a multi-phase voltage regulator logic. Example 11 includes the apparatus of example 1, wherein one or more of: the voltage regulator logic, a processor having one or more processor cores, the interconnection capacitor, and memory are on a single integrated circuit.

Example 12 includes a computing system comprising: memory to store data; a processor, coupled to the memory, to perform one or more operations on the stored data; and an interconnection capacitor coupled to voltage regulator logic, wherein the interconnection capacitor is to provide substrate decoupling for a plurality of loads. Example 13 includes the system of example 12, wherein a first node of the interconnection capacitor is to be coupled to a first node of a first load of the plurality of loads and a second node of the interconnection capacitor is to be coupled to a first node of a second node of the plurality of loads. Example 14 includes the system of example 13, wherein a second node of the first load is to be coupled to the first node of the interconnection capacitor via a first voltage source and a second node of the second load is to be coupled to the second node of the interconnection capacitor via a second voltage source. Example 15 includes the system of example 14, wherein the first voltage source and the second voltage source are to be coupled to the voltage regulator logic. Example 16 includes the system of example 12, wherein the interconnection capacitor is to comprise a capacitor on a semiconductor package or on a motherboard. Example 17 includes the system of example 12, wherein the interconnection capacitor is a separate component on an integrated circuit die or on a load side. Example 18 includes the system of example 12, wherein the interconnection capacitor is to be coupled between the voltage regulator logic and a power source. Example 19 includes the system of example 12, wherein the interconnection capacitor is to be coupled between the voltage regulator logic and the processor having one or more processor cores. Example 20 includes the system of example 12, wherein the voltage regulator logic is to comprise one or more of: a buck voltage regulator logic, a boost voltage regulator logic, or combinations thereof. Example 21 includes the system of example 12, wherein the voltage regulator logic is to comprise a multi-phase voltage regulator logic. Example 22 includes the system of example 12, wherein one or more of: the voltage regulator logic, the processor having one or more processor cores, the interconnection capacitor, and the memory are on a single integrated circuit.

Example 23 includes a method comprising: decoupling a plurality of loads via an interconnection capacitor coupled to voltage regulator logic. Example 24 includes the method of example 23, further comprising providing the interconnection capacitor as a capacitor on a semiconductor package or on a motherboard. Example 25 includes the method of example 23, further comprising providing the interconnection capacitor as a separate component on an integrated circuit die or on a load side. Example 26 includes the method of example 23, further comprising coupling the interconnection capacitor between the voltage regulator logic and a power source. Example 27 includes the method of example 23, further comprising coupling the interconnection capacitor between the voltage regulator logic and a processor having one or more processor cores. Example 28 includes the method of example 23, wherein the voltage regulator logic comprises one or more of: a buck voltage regulator logic, a boost voltage regulator logic, or combinations thereof.

Example 29 includes an apparatus comprising means to perform a method as set forth in any preceding example.

Example 30 comprises machine-readable storage including machine-readable instructions, when executed, to implement a method or realize an apparatus as set forth in any preceding example.

In various embodiments, the operations discussed herein, e.g., with reference to FIGS. 1-10, may be implemented as hardware (e.g., logic circuitry), software, firmware, or combinations thereof, which may be provided as a computer program product, e.g., including a tangible machine-readable or computer-readable medium having stored thereon instructions (or software procedures) used to program a computer to perform a process discussed herein. The machine-readable medium may include a storage device such as those discussed with respect to FIGS. 1-10.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
an interconnection capacitor coupled to voltage regulator logic, wherein the interconnection capacitor is to provide substrate decoupling for a plurality of loads.

2. The apparatus of claim 1, wherein a first node of the interconnection capacitor is to be coupled to a first node of a first load of the plurality of loads and a second node of the interconnection capacitor is to be coupled to a first node of a second node of the plurality of loads.

3. The apparatus of claim 2, wherein a second node of the first load is to be coupled to the first node of the interconnection capacitor via a first voltage source and a second node of the second load is to be coupled to the second node of the interconnection capacitor via a second voltage source.

4. The apparatus of claim 3, wherein the first voltage source and the second voltage source are to be coupled to the voltage regulator logic.

5. The apparatus of claim 1, wherein the interconnection capacitor is to comprise a capacitor on a semiconductor package or on a motherboard.

6. The apparatus of claim 1, wherein the interconnection capacitor is a separate component on an integrated circuit die or on a load side.

7. The apparatus of claim 1, wherein the interconnection capacitor is to be coupled between the voltage regulator logic and a power source.

8. The apparatus of claim 1, wherein the interconnection capacitor is to be coupled between the voltage regulator logic and a processor having one or more processor cores.

9. The apparatus of claim 1, wherein the voltage regulator logic is to comprise one or more of: a buck voltage regulator logic, a boost voltage regulator logic, or combinations thereof.

10. The apparatus of claim 1, wherein the voltage regulator logic is to comprise a multi-phase voltage regulator logic.

11. The apparatus of claim 1, wherein one or more of: the voltage regulator logic, a processor having one or more processor cores, the interconnection capacitor, and memory are on a single integrated circuit.

12. A computing system comprising:
memory to store data;
a processor, coupled to the memory, to perform one or more operations on the stored data; and
an interconnection capacitor coupled to voltage regulator logic, wherein the interconnection capacitor is to provide substrate decoupling for a plurality of loads.

13. The system of claim 12, wherein a first node of the interconnection capacitor is to be coupled to a first node of a first load of the plurality of loads and a second node of the interconnection capacitor is to be coupled to a first node of a second node of the plurality of loads.

14. The system of claim 13, wherein a second node of the first load is to be coupled to the first node of the interconnection capacitor via a first voltage source and a second node of the second load is to be coupled to the second node of the interconnection capacitor via a second voltage source.

15. The system of claim 14, wherein the first voltage source and the second voltage source are to be coupled to the voltage regulator logic.

16. The system of claim 12, wherein the interconnection capacitor is to comprise a capacitor on a semiconductor package or on a motherboard.

17. The system of claim 12, wherein the interconnection capacitor is a separate component on an integrated circuit die or on a load side.

18. The system of claim 12, wherein the interconnection capacitor is to be coupled between the voltage regulator logic and a power source.

19. The system of claim 12, wherein the interconnection capacitor is to be coupled between the voltage regulator logic and the processor having one or more processor cores.

20. The system of claim 12, wherein the voltage regulator logic is to comprise one or more of: a buck voltage regulator logic, a boost voltage regulator logic, or combinations thereof.

21. The system of claim 12, wherein the voltage regulator logic is to comprise a multi-phase voltage regulator logic.

22. The system of claim 12, wherein one or more of: the voltage regulator logic, the processor having one or more processor cores, the interconnection capacitor, and the memory are on a single integrated circuit.
